(19) United States
(12) Patent Application Publication
(10) Pub. No.: US 2006/0085614 A1
(43) Pub. Date: Apr. 20, 2006

(54) Data management apparatus

(75) Inventors: Motohiro Sakai, Kawasaki (JP); Kazuhiko Yamamoto, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/052,772

(22) Filed: Feb. 9, 2005

(30) Foreign Application Priority Data
Oct. 15, 2004 (JP) 2004-301672

(51) Int. Cl. G06F 12/00

(52) U.S. Cl. 711/163; 711/165; 711/171

(57) ABSTRACT

Hierarchical storage management is performed using a primary storage device and a secondary storage device. A suppression process unit suppresses the data operation requested by another device if data requested to read by the device is not stored in the primary device. A block size setting process unit sets the data size of a block, based on the size of the data requested to read when storing the data in the primary device in units of blocks. A data writing process unit writes data read from the secondary device into the primary device one and after in units of the blocks whose data size is set if the data requested to read is not stored in the primary device. A release process unit releases the suppression of data operation of only already written data one and after every time the data is written into the primary device.

### BACKGROUND OF THE INVENTION

1. Field of the Invention

The present invention relates to a data management technology, more particularly, to the generation management technology of backup files.

2. Description of the Related Art

A variety of data handled by information systems is recorded in and managed by a storage device. As a technology for managing a large amount of data, for example, the following three technologies have been conventionally used.

(1) A redundant arrays of inexpensive disks (RAID) technology for providing a large-capacity logic disk while sustaining the high speed of data access and improving the reliability of data storage by combining a plurality of fairly inexpensive disk devices

(2) A multi-volume technology in which a file system used in a host server virtually connects a plurality of volumes of storage devices and manages it as a large volume

(3) A hierarchical storage management (HSM) technology capable of storing data whose amount exceeds the capacity of a disk storage device, by hierarchically combining a disk storage device with high data access with a media library storage using a large capacity of removable media, such as a magnetic tape and the like and moving data among these devices, as requested

Besides, as to the present invention, for example, Japanese Patent Application No. Hei7-244600 discloses a technology to restore data for providing a stale file management table for managing files which is deleted from the management table and in the storage area of which substantial data still remains and for switching stale files to backup files. Japanese Patent Application No. Hei11-242570 discloses a technology that an operator can handle all data as data in a magnetic disk without being aware of accessing a magnetic tape in a magnetic tape library device and an external storage device provided with a magnetic disk device.

Now, the above-mentioned three technologies have the following problems.

The management cost of the RAID technology increases as its storage capacity increases, since hard disk devices are combined. Since in the RAID technology, the number of combined devices is limited for the reason of storage capacity and reliability, there is a limit in its storage capacity if a storage system is organized by only the RAID technology.

Since in virtual volume management by a file system, a file system is essential, the virtual volume management cannot be applied to application for directly accessing without passing through the file system.

The HSM technology has an advantage that a large capacity of data can be managed while suppressing its management cost. However, in the HSM technology, it is difficult to handle data placed out of the control of a file system. Since a host server moves data between layers, server resources are consumed, which is a problem.

In view of such problems, a hybrid type data management apparatus that has a high-speed disk device and a large-capacity removable media library device built-in, can suppress the consumption of resources on the host side by autonomously performing hierarchical storage management within the device, and can be recognized as a virtual disk device in which the existence of removable media is not recognized and which looks a transparent storage space by the host system side is studied.

If requested data does not exists in a disk device which is a primary storage device when receiving a data read request from a host system, this data management apparatus reads the relevant data from a removable media library device which is a secondary storage device, writes the data into the primary storage device and prepares for future data access from the host system (recall operation). In other words, in this recall operation, a process of writing data into the primary storage device is performed.

If data is read while data is being written into a storage device, there is a possibility that old data may be read from the storage device by mistake. Therefore, during such a period, data is prevented from being read, that is, exclusive control is performed. However, since in the exclusive control, a reading process is prohibited until all writing processes are completed, for example, data cannot be read although requested data is the already written in a storage device in the initial stage. As a result, a reply to the data read request from the host system is wastefully delayed, which is a problem.

### SUMMARY OF THE INVENTION

It is an object of the present invention to reduce the delay in reply of a storage device, due to exclusive control.

One aspect of the present invention is a data management apparatus. The data management apparatus performs hierarchical storage management, using a primary storage device and a secondary storage device. The data management apparatus comprises a suppression process unit for suppressing data operation requested by another device if the data requested to read by the device is not stored in the primary storage device, a block size setting process unit for setting the data size of a block, based on the size of the requested data when storing the data in the primary storage device in units of blocks, a data writing process unit for writing data read from the secondary storage device into the primary storage device one after another in units of the blocks whose data size is set described above if the requested data is not stored in the primary storage device, and a release process unit for releasing the suppression of the data operation which is targeted to only already written data every time data is written into the primary storage device in units of the blocks.

According to this data management apparatus, the delay in reply of a storage device, due to exclusive control can be reduced.

### BRIEF DESCRIPTION OF THE DRAWINGS

The present invention will be more apparent from the following detailed description when the accompanying drawings are referenced to.

FIG. 1 shows the basic configuration of a data management apparatus implementing the present invention.

FIG. 2 shows the detailed configuration of the data management apparatus implementing the present invention.

FIG. 3 explains the summary of the recall operation of the data management apparatus shown in FIG. 2.

FIG. 4 is a flowchart showing the contents of a data reading control process.

FIG. 5 shows examples of a computer-readable storage medium on which is recorded a control program.

### DESCRIPTION OF THE PREFERRED EMBODIMENTS

The preferred embodiments of the present invention are described below with reference to the drawings.

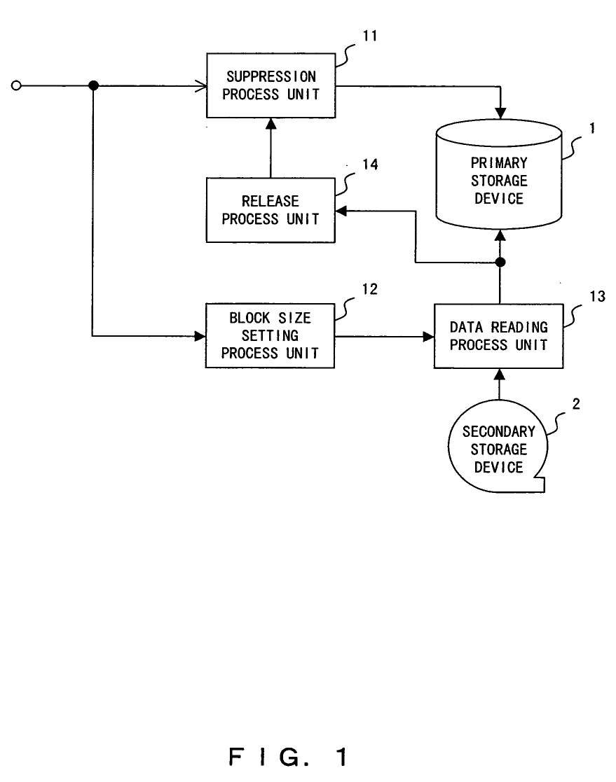

Firstly, FIG. 1 is described. FIG. 1 shows the basic configuration of a data management apparatus implementing the present invention. The data management apparatus performs hierarchical storage management, using a primary storage device 1 and a secondary storage device 2.

A suppression process unit 11 suppresses data operation requested by another device if the data requested to read by the device is not stored in the primary storage device 1.

A block size setting process unit 12 sets the data size of a block, based on the size of the requested data when storing the data in the primary storage device 1 in units of blocks.

A data writing process unit 13 writes data read from the secondary storage device 2 into the primary storage device 1 one after another in units of the blocks whose data size is set if the requested data is not stored in the primary storage device 1.

A release process unit 14 releases the suppression of the data operation to be targeted to only already written data every time data is written into the primary storage device 1 in units of the blocks.

According to the configuration shown in FIG. 1, the data writing process unit 13 writes data read from the secondary storage device 2 one after another in units of blocks, whereas the release process unit 14 releases the data operation to be targeted to only already written data of the exclusive control performed by the suppression process unit 11. Thus, the delay in reply of the data management apparatus, due to the exclusive control can be reduced.

The above-mentioned data management apparatus of the present invention can also further comprise a data transmitting unit for reading data requested by another device from the primary storage device 1 and transmitting the data to the device, and the suppression process unit 11 can also suppress the reading of data from the primary storage device 1 by the data transmitting unit.

This configuration suppresses the transmission of data requested by another device.

The above-mentioned data management apparatus of the present invention can also be configured that the data writing process unit 13 reads data from the secondary storage device 2 one after another in units of the block whose data size is set as described above and stores the data in the primary storage device 1 if the requested data is not stored in the primary storage device 1.

According to this configuration, since data is read from the secondary storage device 2 in units of blocks, memory capacity needed to temporarily store read data can be reduced.

The same function effect as those devices can also be obtained by a data management method adopted by the data management apparatus shown in FIG. 1. Furthermore, the same function effect as those devices can also be obtained by executing a program for enabling a computer to perform the processes performed by these devices.

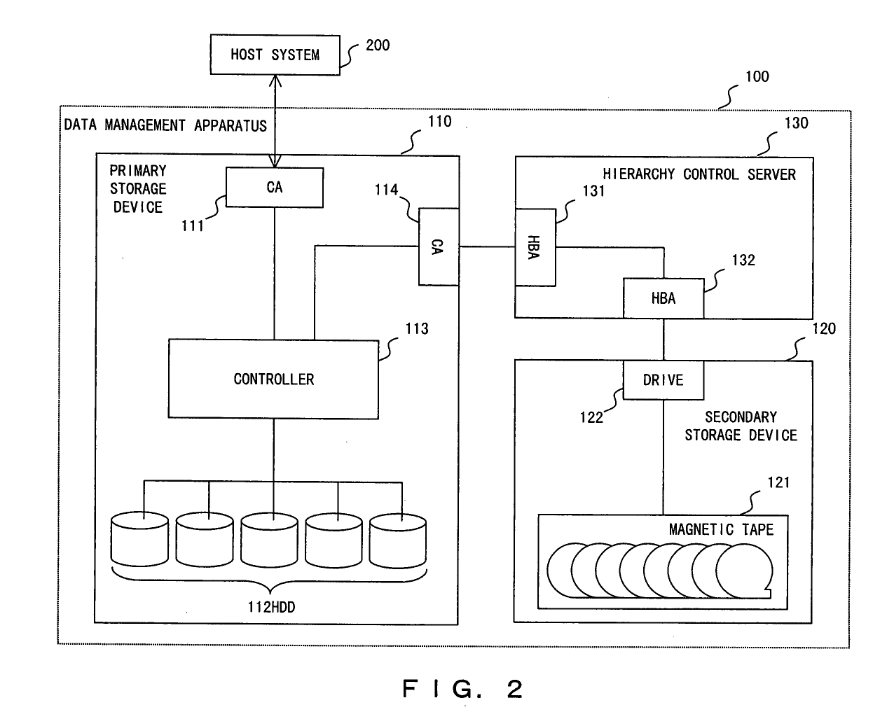

Next, FIG. 2 is described. FIG. 2 shows the detailed configuration of the data management apparatus implementing the present invention.

A data management apparatus 100 stores backup data covering a plurality of generations which is received from a host system 200, and manages their generations. Then, the data management apparatus 100 transmits the requested backup data to the host system 200 upon request from the host system 200.

The data management apparatus 100 comprises a primary storage device 110, a secondary storage device 120 and a hierarchy control server 130 for performing such hierarchical storage management (HSM).

A channel adapter (CA) 111 provided for the primary storage device 110 transmits/receives data to/from the host system 200.

A hard disk drive (HDD) 112 is a data storage medium used as a primary storage device in HSM.

A controller 113 is used to manage data storage in the HDD 112, and stores data transmitted from the host system 200 in the HDD 112.

The CA 114 manages the transmission/reception of data from/to the hierarchy control server 130.

A magnetic tape 121 provided for the secondary storage device 120 is an addition type data storage device used as a secondary storage device in HSM. A compact disk (CD), a digital versatile disk (DVD) or the like can also be used as the addition type data storage device, instead of the magnetic tape 121.

A drive 122 manages data storage in the magnetic tape 121.

In the hierarchy control server 130, a host bus adapter (HBA) 131 manages the transmission/reception of data to/from the primary storage device 110, and an HBA 132 manages the transmission/reception of data to/from the secondary storage device 120. The hierarchy control server 130 realizes HSM in the data management apparatus 100 by controlling the operation of the secondary storage device 120, according to instructions transmitted from the primary storage device 110.

The hierarchy control server 130 comprises a central processing unit (CPU), read-only memory (ROM) and random-access memory (RAM), which are not shown in FIG. 2. The above-mentioned operation control is realized by enabling the CPU to read and execute a control program stored in the ROM in advance. The RAM provides a working storage area needed when the CPU executes this control program.

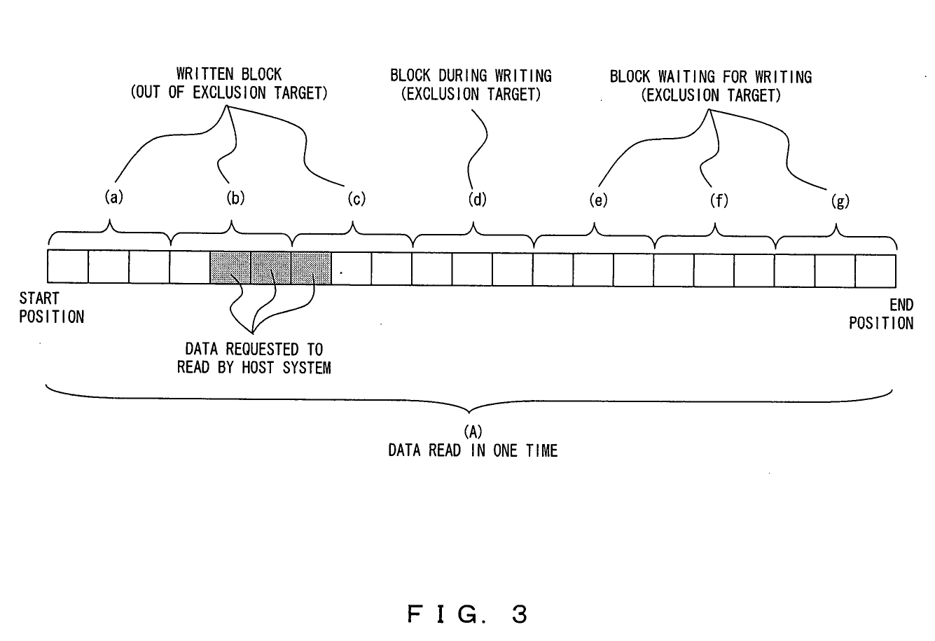

Next, the summary of a recall operation performed in the data management apparatus 100 is described with reference to FIG. 3.

When detecting the reception of a read request of data which does not remain in the HDD 112 of the primary storage device 110, from the host system 200, the controller 113 starts exclusive control and nullifies a data operation request (such as a data read request, etc.) from the host system 200 which is received by the CA 111. Simultaneously, the controller 113 issues the transfer request of requested data (that is, a request of recall operation) to the hierarchy control server 130.

Upon receipt of this recall operation request, the hierarchy control server 130 performs a recall operation, that is, reads a prescribed amount of data including the requested data from the magnetic tape 121 of the secondary storage device 120 and transfers the data to the primary storage device 110. In the example shown in FIG. 3, it is assumed that data described as (A), included between a start position and an end position is read by the recall operation.

Upon receipt of this data, the controller 113 of the primary storage device 110 divides data received from the secondary storage device 120 into a plurality of blocks and writes data in the HDD 112 one after another in units of blocks. In this case, the controller 113 sets the data size of a block, based on the size of data requested to read from the host system 200.

In the example shown in FIG. 3, data (A) is divided into seven blocks (blocks (a), (b), (c), (d), (e), (f) and (g)) as a result of the setting by the controller 113. Although in this example, the data size of each data block after division is the same as the size of requested data, this is not indispensable.

Every time the divided data is written into the HDD 112 in units of blocks, the controller 113 releases exclusive control which is targeted to only the already written data and enables the data management apparatus 100 to reply to the operation request of the data from the host system 200.

As described above, by writing data read from the secondary storage device 120 into the HDD 112 one after another in units of blocks and also by releasing exclusive control which is targeted to only the already written data, the delay in reply to the host system 200 of the data management apparatus 100, due to exclusive control can be reduced.

For example, it is assumed that data requested to read from the host system 200 is the meshed portion in FIG. 3. In the prior art, data (A), that is, data included in data blocks (a) through (g) are all written into the HDD 112, then the exclusive control is released, and the requested data is transmitted to the host system 200. However, in this preferred embodiment, if only data included data blocks (a), (b) and (c) is written into the HDD 112, the exclusive control of data including requested data is immediately released. Therefore, for example, while data included in data block (d) is being written into the HDD 112, requested data can be transmitted to the host system 200. Thus, the delay in reply to the host system 200 of the data management apparatus 100 can be reduced.

In the example shown in FIG. 3, the size of each data block after division is assumed to be the same as size of data requested by the host system 200. In this case, if the data size of each data block is larger than that of requested data, the present invention proportionally gets closer to the prior art. Therefore, the reduction effect of delay in reply decreases. If the data size of each data block is smaller than that of requested data, writing times needed to complete all the writing of requested data increase, and as a result, the reduction effect of delay in reply decreases. Therefore, it is preferable to select an appropriate data block size by comparing/considering both cases and furthermore taking into consideration the size of requested data.

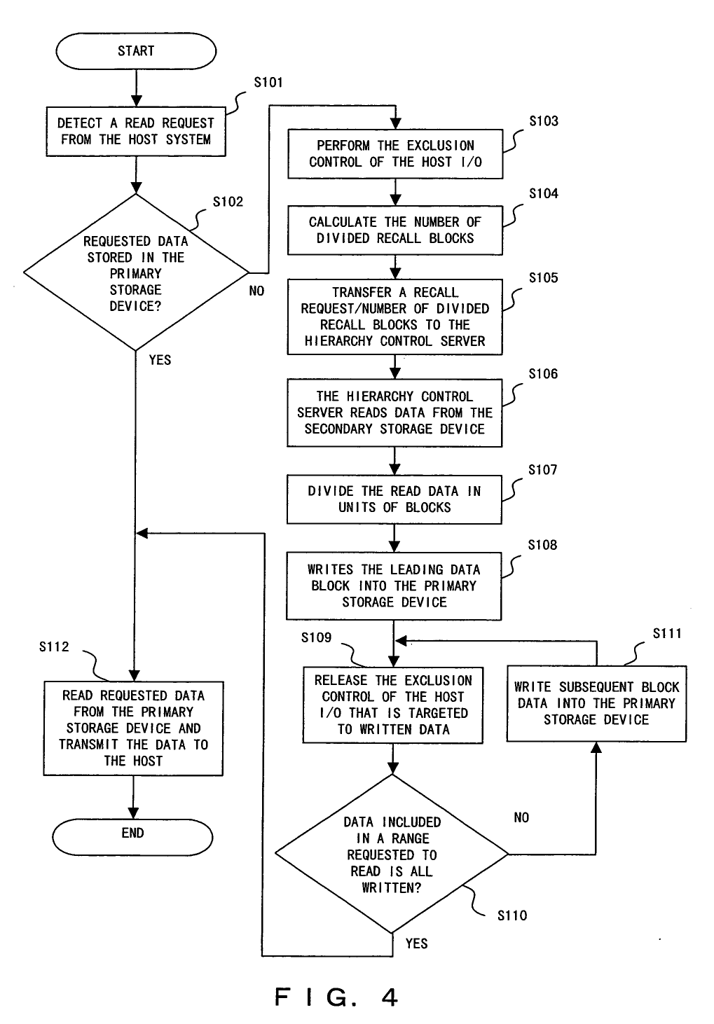

Next, FIG. 4 is described. FIG. 4 is a flowchart showing the contents of a data reading control process. This process starts when the host system 200 issues a data read request to the data management apparatus 100.

Firstly, in S101, the controller 113 of the primary storage device 110 detects that the CA 111 has received a data read request from the host system 200.

Then, S102, the controller 113 determines whether data, which is a target of the detected data read request, is stored in the HDD 112 of the primary storage device 110. If the requested data is stored in the HDD 112 (the determination result is yes), the flow proceeds to S112. If the requested data does not remain in the HDD 112 (the determination result id no), the flow proceeds to S103.

In S103, the controller 113 performs the exclusive control of the interface with the host system 200 by the CA 111.

In S104, the controller 113 sets the data size of the above-mentioned block based on the data size of the data requested by the host system 200, and calculates the number of divided blocks of data to recall by the recall operation of the secondary storage device 120, based on this data size. Information about the data size of the requested data can be obtained, for example, from the host system 200. Alternatively, the history of the previous data operations can be stored in the controller 113, and the information can be obtained from this history.

In S105, The controller 113 requests the hierarchy control server 130 to recall via the CA 114 and transfers the number of divided blocks of the requested data to recall to the hierarchy control server 130 via the CA 114.

Upon receipt of both the recall request and the number of divided blocks, in S106, the hierarchy control server 130 controls the drive 122 of the secondary storage device 120 via the HBA 132 to read the requested data from the magnetic tape 121. Then, the secondary storage device 120 transmits the data read from the magnetic tape 121 to the hierarchy control server 130.

Upon receipt of the data from the secondary storage device 120, in S107, the hierarchy control device 130 divides the data into the number designated by the controller 113, of blocks.

In S108, the HBA 131 of the hierarchy control server 130 transmits the leading block of the divided data blocks to the primary storage device 110. Upon receipt of this data, the controller 113 of the primary device 110 writes the received data into the HDD 112.

In S109, the controller 113 releases exclusive control which is targeted to data written into the HDD 112 in the immediately previous process of all the exclusive control of the interface with the host system 200 by the CA 111, one after another.

In S110, the controller 113 determines whether data included in the range requested by the host system 200 is written into the HDD 112. If the data is already written (the determination result is yes), the flow proceeds to S112. If the data is not written yet (the determination result is no), the flow proceeds to S111.

In S111, The HBA 131 of the hierarchy control server 130 transmits divided block data to write next to the primary storage device 110. Upon receipt of this data, the controller 113 of the primary storage device 110 writes the received data into the HDD 112. Then, the flow returns to S109, and the above-mentioned process is repeated.

In S112, the controller 113 reads the data requested to read by the host system 200 from the HDD 112, and controls the CA 111 to transmit the data to the host system 200. Then, this data reading control process terminates.

So far the data reading control process has been described. By performing this process in the data management apparatus 100, the data read from the secondary storage device 120 is written into the HDD 112 one after another in units of blocks, and also only exclusive control which is targeted to the written data is released one after another. As a result, the delay in reply to the host system 200 of the data management apparatus 100 can be reduced.

In FIG. 4, in the processes in S106 through S111, data read from the magnetic tape 121 of the secondary storage device 120 is divided in units of blocks, and the divided data is written into the HDD 112 of the first storage device 110 in units of the blocks. However, the data can also be read from the magnetic tape 121 one after another in units of blocks, and can also be stored in the HDD 112 immediately after the data is read. Thus, the memory capacity needed to temporarily store data read from the magnetic tape 121 can be reduced.

A computer with a standard configuration, that is, a computer comprising a central processing unit (CPU) for controlling each component by executing a control program, a storage unit composed of read-only memory (ROM), random-access memory (RAM), a magnetic storage device or the like, used to store the control program for enabling the CPU to control each component and used as a work area or the storage area of a variety of data when the CPU executes the control program, an input unit for inputting a variety of data in accordance with user's operations, an output unit for presenting a variety of data to a display or the like to notify a user of the data and an interface (I/F) unit for providing an interface function to transmit/receive data to/from another device can also implement the present invention by enabling the computer to execute the process shown in the flowchart of FIG. 4 in a system where a storage device for writing/reading data into/from a storage medium is connected.

This can be realized by coding a control program for enabling this computer to execute the process shown in the flowchart of FIG. 4, recording the program on a computer-readable storage medium and making the computer to read the program from the storage medium and execute the program.

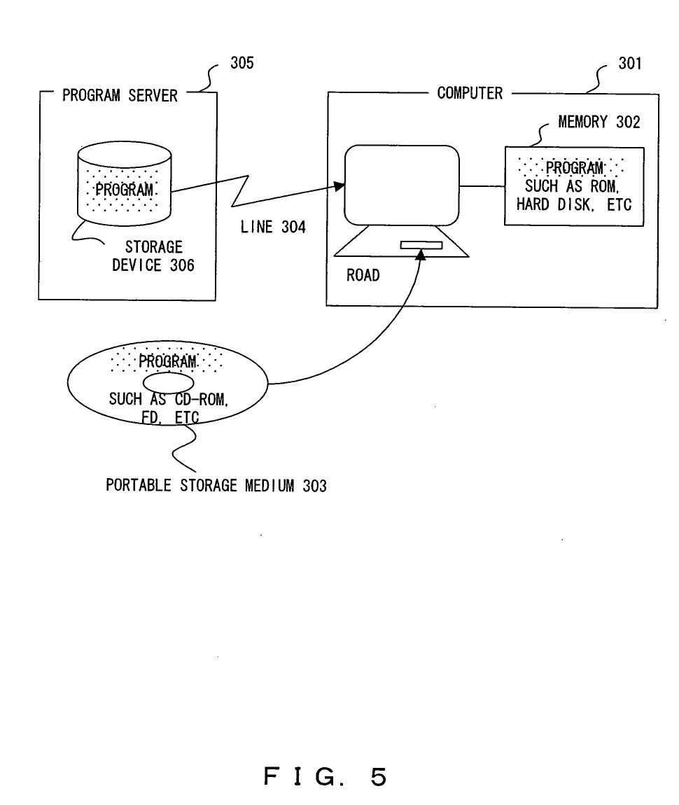

FIG. 5 shows examples of a computer-readable storage medium on which is recorded a control program. As shown in FIG. 5, for the storage medium, memory 302, such as RAM, ROM, a hard disk device which are built in or externally attached to a computer 301, etc., a portable storage medium 303, such as a flexible disk (FD), a magneto-optical disk (MO), compact-disk (CD)-ROM, digital versatile disk (DVD)-ROM, etc., or the like can be used. The storage medium can also be a storage device 306 which is connected to the computer 301 via a line 304 and is provided for a computer functioning as a program server 305. In this case, the control program can be executed by transmitting a transmission signal obtained by data signals representing the control program with a carrier wave from the program server 305 to the computer 301 via the line 304 which is a transmission medium, and reproducing the control program in the computer 301 by demodulating the received transmission signal.

The present invention is not limited to the above-mentioned preferred embodiments, and its variations and modifications are also possible.

What is claimed is:

1. A data management apparatus for performing hierarchical storage management using a primary storage device and a secondary storage device, comprising:
a suppression process unit for suppressing data operation requested by another device if the data requested to read by the device is not stored in the primary storage device;
a block size setting process unit for setting the data size of a block, based on the size of the data requested to read when storing the data in the primary storage device in units of blocks;
a data writing process unit for writing data read from the secondary storage device into the primary storage device one after another in units of the blocks whose data size is set if the requested data is not stored in the primary storage device; and
a release process unit for releasing the suppression of the data operation which is targeted to only already written data every time the data is written into the primary storage device in units of the blocks.

2. The Device according to claim 1, further comprising
a data transmitting unit for reading the data requested to read by another device from the primary storage device and transmitting the data to the device, wherein
said suppression process unit suppresses the reading of data from the primary storage device by the data transmitting unit.

3. The Device according to claim 1, wherein
said data writing process unit reads data from the secondary storage device one after another in units of the blocks after setting and stores the data in the primary storage device if the data requested to read is not stored in the primary storage device.

4. A data management apparatus for performing hierarchical storage management using a primary storage device and a secondary storage device, comprising:
suppression process means for suppressing data operation requested by another device if the data requested to read by the device is not stored in the primary storage device;
block size setting process means for setting the data size of a block, based on the size of the data requested to read when storing the data in the primary storage device in units of blocks;
data writing process means for writing data read from the secondary storage device into the primary storage device one after another in units of the blocks whose data size is set if the requested data is not stored in the primary storage device; and
release process means for releasing the suppression of the data operation which is targeted to only already written data every time the data is written into the primary storage device in units of the blocks.

5. A data management method for performing hierarchical storage management using a primary storage device and a secondary storage device, comprising:
suppressing data operation requested by another device if the data requested to read by the device is not stored in the primary storage device;
setting the data size of a block, based on the size of the data requested to read when storing the data in the primary storage device in units of blocks;
writing data read from the secondary storage device into the primary storage device one after another in units of the blocks whose data size is set if the requested data is not stored in the primary storage device; and
releasing the suppression of the data operation which is targeted to only already written data every time the data is written into the primary storage device in units of the blocks.

6. A storage medium on which is recorded a program for enabling a computer to perform hierarchical storage management using a primary storage device and a secondary storage device, said program comprising:
suppressing data operation requested by another device if the data requested to read by the device is not stored in the primary storage device;
setting the data size of a block, based on the size of the data requested to read when storing the data in the primary storage device in units of blocks;
writing data read from the secondary storage device into the primary storage device one after another in units of the blocks whose data size is set if the requested data is not stored in the primary storage device; and
releasing the suppression of the data operation which is targeted to only already written data every time the data is written into the primary storage device in units of the blocks.

7. A computer data signal embodied in a carrier wave, and representing a program for enabling a computer to perform hierarchical storage management using a primary storage device and a secondary storage device, said program comprising:
suppressing data operation requested by another device if the data requested to read by the device is not stored in the primary storage device;
setting the data size of a block, based on the size of the data requested to read when storing the data in the primary storage device in units of blocks;
writing data read from the secondary storage device into the primary storage device one after another in units of the blocks whose data size is set if the requested data is not stored in the primary storage device; and
releasing the suppression of the data operation which is targeted to only already written data every time the data is written into the primary storage device in units of the blocks.
